(19) United States
(12) Patent Application Publication
(10) Pub. No.: US 2025/0383326 A1
(43) Pub. Date: Dec. 18, 2025

(54) COLUMN FOR HIGH PERFORMANCE LIQUID CHROMATOGRAPHY (HPLC) AND MANUFACTURING METHOD THEREOF

(71) Applicant: Tomoe Works Co., Ltd., Osaka (JP)

(72) Inventors: Yuji Toyoda, Osaka (JP); Katsuhiro Takai, Osaka (JP); Toshio Uemura, Osaka (JP)

(73) Assignee: Tomoe Works Co., Ltd., Osaka (JP)

(21) Appl. No.: 19/061,202

(22) Filed: Feb. 24, 2025

(30) Foreign Application Priority Data
Jun. 17, 2024 (JP) 2024-97629

(51) Int. Cl. G01N 30/60

(52) U.S. Cl. CPC G01N 30/6004; G01N 30/6052

(57) ABSTRACT

The invention is related to a column and a manufacturing method thereof, the column being characterized in that it comprises filters provided between a column main body part and end fittings, and sleeves equipped around the filters, wherein the filters and the sleeves configure integrated structure bodies, wherein the structure bodies are placed or fixed inside the end fittings, wherein the filters have outer diameters smaller than an inner diameter of the main body part, wherein the structure bodies have outer diameters larger than the inner diameter of the main body part, wherein when the end fittings are attached to the main body part, the sleeves are compressed, the filters are not compressed, and the filters are present inside the main body part.

### BACKGROUND OF THE INVENTION

### Field of the Invention

The present invention is related to a column for High Performance Liquid Chromatography (HPLC) and a manufacturing method thereof.

### Description of Related Art

High Performance Liquid Chromatography (HPLC) is one of the analytical methods widely used for separation and purification of the components of a sample. It is based on the mechanism that when the sample moves through a column packed with a filler, the mixed components of the sample are separated and purified according to the difference in their movement speeds.

The precision of separation and purification with HPLC varies depending on various conditions, but as an example, a column packed with a filler uniformly arranged without gaps is considered as a column with good analytical performance. One of the indicators showing the analytical performance of a column is the theoretical plate number; the larger its value, the sharper the peak, and the column is determined to have good analytical performance.

On the other hand, as described in Japanese Unexamined Patent Publication No. 2006-275652 and Japanese Unexamined Patent Publication No. 2016-90336, in the art, when a column is packed with a filler, the filler is packed densely at the lower part of the column, but the packing state at the upper end of the column becomes loose at the moment the packer is removed, which is usually recognized to cause top-off phenomenon.

Japanese Unexamined Patent Publication No. 2006-275652 discloses a manufacturing method of a column that can prevent top-off phenomenon by a method of placing at the end of the column a frit with the same diameter as the inner diameter of the column and applying pressure to a filler-packed layer by pressing a gel therein. In the invention of Japanese Unexamined Patent Publication No. 2006-275652, the outer periphery of the frit is surrounded by a resin with water resistance such as fluorine-based resin, and the like, so that the frit can be closely attached to the inner wall of the column, but since the fluorine-based resin does not have high stiffness, there is a possibility that a gap will be generated when the frit is closely attached to and slides along the inner wall of the column. Also, it is not preferable for the fluorine-based resin to get inside the column and has an increased surface area in contact with the filler and the sample.

Japanese Unexamined Patent Publication No. 2016-90336 describes that the entire press-fit component is press-fitted into the column body packed with a filler, ensuring sufficient packing density of the filler. However, Japanese Unexamined Patent Publication No. 2016-90336 describes the press-fit component “allowing liquid such as eluent to pass through”, in other words, enlarging the press-fit component lowers analytical performance since the press-fit component itself becomes extra-column volume which causes the widening of peak bands. Also, since there is no gasket or sleeve, the structure is unlikely to completely prevent leakage of the sample.

In addition, although a column with a different size may be selected according to its use and purpose, those with an inner diameter of 3 mm or more and less than 10 mm are classified as general-purpose columns according to the Japanese Industrial Standards, and among these, columns with an inner diameter of 4.6 mm are used most frequently. On the other hand, if numerous components are used to improve the analytical performance of a column and the structure and mechanism become complex, the column itself tends to become large-scale and expensive.

### BRIEF SUMMARY OF THE INVENTION

### Problems to be Solved by the Invention

As mentioned above, the problem to be solved in analyzing samples using HPLC is to resolve the top-off phenomenon that occurs when a filler is densely packed at the lower part of a column but loosely packed at the upper part thereof, thereby developing a column having a simple structure and mechanism with few components, while preserving more superior analytical performance and decreasing, to the greatest extent, the area where the sample or the filler come into contact with a sleeve.

### Means for Solving the Problems

An invention according to a first aspect of the present invention is related to a column for high performance liquid chromatography (HPLC), the column comprising: a main body part comprising a filler inside thereof; end fittings attached to both ends of the main body part; filters provided between the main body part and the end fittings; and sleeves equipped around the filters, wherein the filters and the sleeves configure integrated structure bodies, wherein the structure bodies are placed or fixed inside the end fittings, wherein the filters have outer diameters smaller than an inner diameter of the main body part, wherein the structure bodies have outer diameters larger than the inner diameter of the main body part, wherein the filters are made of a material that does not deform when the end fittings are attached to the main body part, wherein the sleeves are made of a material that is deformable when the end fittings are attached to the main body part, wherein the column is characterized in that when the end fittings are attached to the main body part, the sleeves are compressed, the filters are not compressed, and the filters are present inside the main body part so as to resolve a top-off by the filler.

An invention according to a second aspect of the present invention is related to the column of the first aspect, wherein at least one of the main body part, the end fittings, and the filters is made of metal.

An invention according to a third aspect of the present invention is related to the column of the first aspect, wherein at least one of the main body part, the end fittings, and the filters is made of synthetic resin.

An invention according to a fourth aspect of the present invention is related to a manufacturing method of a column for high performance liquid chromatography (HPLC), the manufacturing method comprising: (a) obtaining structure bodies in which filters and sleeves are integrated by press-fitting the filters into the sleeves; and (b) placing or fixing the structure bodies to end fittings of the column, wherein the column comprises a main body part comprising a filler inside thereof, the end fittings attached to both ends of the main body part, and the structure bodies between the main body part and the end fittings, wherein the filters are made of a material that does not deform upon attachment of the end fittings to the main body part, wherein the sleeves are made of a material that is deformable upon attachment of the end fittings to the main body part, wherein the filters have outer diameters smaller than an inner diameter of the main body part, wherein the structure bodies have outer diameters larger than the inner diameter of the main body part, wherein the column is characterized in that upon attachment of the end fittings to the main body part, the sleeves are compressed so that the filters are inserted into the main body part.

An invention according to a fifth aspect of the present invention is related to the manufacturing method of a column for HPLC of the fourth aspect, wherein at least one of the main body part, the end fittings, and the filters is made of metal.

An invention according to a sixth aspect of the present invention is related to the manufacturing method of a column for HPLC of the fourth aspect, wherein at least one of the main body part, the end fittings, and the filters is made of synthetic resin.

### Effects of the Invention

According to the invention of the first aspect, the invention is a column for high performance liquid chromatography (HPLC), the column comprising: a main body part comprising a filler inside thereof; end fittings attached to both ends of the main body part; filters provided between the main body part and the end fittings; and sleeves equipped around the filters, wherein the filters and the sleeves configure integrated structure bodies, wherein the structure bodies are placed or fixed inside the end fittings, wherein the filters have outer diameters smaller than an inner diameter of the main body part, wherein the structure bodies have outer diameters larger than the inner diameter of the main body part, wherein the filters are made of a material that does not deform when the end fittings are attached to the main body part, wherein the sleeves are made of a material that is deformable when the end fittings are attached to the main body part, wherein the column is characterized in that when the end fittings are attached to the main body part, the sleeves are compressed, the filters are not compressed, and the filters are present inside the main body part so as to resolve a top-off by the filler; and thus, the invention can provide a column having a simple structure and mechanism with few components, while making the filler loosely packed at the upper part of the column into a closely packed state, decreasing, to the greatest extent, the area where the sample or the filler comes into contact with the sleeves, preventing leakage of the filler, and having superior analytical performance.

According to the invention of the second aspect, the invention is the column of the first aspect, wherein at least one of the main body part, the end fittings, and the filters is made of metal; and thus, the invention can provide a column that has superior heat resistance and pressure resistance in addition to not causing adsorption or denaturation of the sample.

According to the invention of the third aspect, the invention is the column of the first aspect, wherein at least one of the main body part, the end fittings, and the filters is made of synthetic resin; and thus, the invention can provide a column that has superior heat resistance and pressure resistance in addition to not causing adsorption or denaturation of the sample and not causing rust.

According to the invention of the fourth aspect, the invention is a manufacturing method of a column for high performance liquid chromatography (HPLC), the manufacturing method comprising: (a) obtaining structure bodies in which filters and sleeves are integrated by press-fitting the filters into the sleeves; and (b) placing or fixing the structure bodies to end fittings of the column, wherein the column comprises a main body part comprising a filler inside thereof, the end fittings attached to both ends of the main body part, and the structure bodies between the main body part and the end fittings, wherein the filters are made of a material that does not deform upon attachment of the end fittings to the main body part, wherein the sleeves are made of a material that is deformable upon attachment of the end fittings to the main body part, wherein the filters have outer diameters smaller than an inner diameter of the main body part, wherein the structure bodies have outer diameters larger than the inner diameter of the main body part, wherein the column is characterized in that upon attachment of the end fittings to the main body part, the sleeves are compressed so that the filters are inserted into the main body part; and thus, the invention can provide a manufacturing method of a column having a simple structure and mechanism with few components, while making the filler loosely packed at the upper part of the column into a closely packed state, decreasing, to the greatest extent, the area where the sample or the filler comes into contact with the sleeves, preventing leakage of the filler, and having superior analytical performance.

According to the invention of the fifth aspect, the invention is the manufacturing method of a column for HPLC of the fourth aspect, wherein at least one of the main body part, the end fittings, and the filters is made of metal; and thus, the invention can provide a manufacturing method of a column that has superior heat resistance and pressure resistance in addition to not causing adsorption or denaturation of the sample.

According to the invention of the sixth aspect, the invention is the manufacturing method of a column for HPLC of the fourth aspect, wherein at least one of the main body part, the end fittings, and the filters is made of synthetic resin; and thus, the invention can provide a column that has superior heat resistance and pressure resistance in addition to not causing adsorption or denaturation of the sample and not causing rust.

### BRIEF DESCRIPTION OF DRAWINGS

FIG. 1 is a schematic diagram of an interior structure of a column 1 configured by a main body part 2, end fittings 3 and structure bodies 6.

FIG. 2a is a sectional view of a conventional filter 4′, a conventional sleeve 5′, and a part of main body part 2, in a conventional column 1′ being packed with a filler followed by attachment of an end fitting 3 which comprises structure body of the conventional filter 4′ and the conventional sleeve 5′. FIG. 2b is a sectional view of a filter 4, a sleeve 5, and a part of main body part 2, in a column 1 of the present invention having an end fitting 3 attached which comprises a structure body 6 of the filter 4 and the sleeve 5.

FIG. 3 is a figure showing the results of analyzing a sample in which uracil, ethyl benzoate, acenaphthene, and butylbenzene were mixed, using the column 1 of the present invention.

FIG. 4 is a figure showing the results of analyzing a sample in which uracil, ethyl benzoate, acenaphthene, and butylbenzene were mixed, using the conventional column 1′.

### DETAILED DESCRIPTION OF THE INVENTION

### Description of Embodiments

Embodiments of a column for high performance liquid chromatography (HPLC) according to the present invention will be explained below in detail with reference to the drawings.

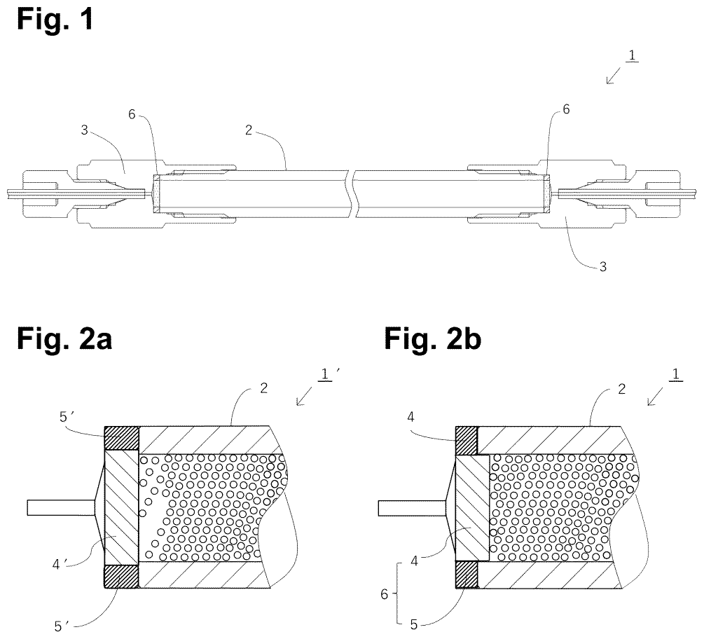

FIG. 1 is a schematic diagram of an interior structure of a column 1 configured by a main body part 2, end fittings 3, and structure bodies 6 consisting of filters 4 and sleeves 5.

The column 1 according to the present invention comprises a main body part 2 comprising a filler inside thereof, end fittings 3 attached to both ends of the main body part 2, filters 4 provided between the main body part 2 and the end fittings 3, and sleeves 5 equipped around the filters 4.

The main body part 2 is a part where separation of each component in a sample takes place in the column 1 according to the present invention, and comprises a filler inside thereof.

The main body part 2 is preferable to be made of, for example, a synthetic resin or a metal having characteristics of excellent heat resistance and pressure resistance in addition to not causing adsorption or denaturation of the sample. Examples for such synthetic resin include PEEK, and the like, and examples for such metal include stainless steel, and the like, but other materials can be also optionally selected if these have characteristics of excellent heat resistance and pressure resistance in addition to not causing adsorption or denaturation of samples.

The length of main body part 2 is preferably, but not limited to, between 1 mm to 1000 mm. The length, such as 8 mm, 10 mm, 20 mm, 30 mm, 35 mm, 50 mm, 75 mm, 100 mm, 125 mm, 150 mm, 200 mm, 250 mm, 300 mm, 350 mm, 400 mm, 450 mm, 500 mm, 550 mm, 600 mm, 650 mm, 700 mm, 750 mm, 800 mm, 850 mm, 900 mm, 950 mm, and 1000 mm, can be selected and used, but other lengths can be also optionally selected.

The inner diameter of main body part 2 is preferably, but not limited to, between 0.1 mm to 100 mm. The inner diameter, such as 0.5 mm, 1.0 mm, 2.0 mm, 2.1 mm, 3.0 mm, 4.0 mm, 4.6 mm, 5.0 mm, 6.0 mm, 7.5 mm, 7.8 mm, 8.0 mm, 10.0 mm, 20.0 mm, 30.0 mm, and 50.0 mm, can be selected and used, but other inner diameters can be also optionally selected.

For the filler, there is no particular limitation as long as it is used in sample analysis. For example, types of fillers that can be used include silica gel, polymer gel, zirconia, and a filler having silica gel that has been surface-treated with an octadecylsilyl group, and the like, but other fillers can be also optionally selected.

The end fittings 3 are attached to connect the column 1 according to the present invention to a HPLC analytical instrument, and are attached to both ends of the main body part 2. The end fittings 3 have the structure bodies 6 fixed, and thus, can prevent the sample and the filler from leaking out.

The end fittings 3 have the structure bodies 6 placed or fixed inside thereof to be used.

The end fittings 3 are preferable to be made of, for example, a synthetic resin or a metal having characteristics of excellent heat resistance and pressure resistance in addition to not causing adsorption or denaturation of the sample. Examples for such synthetic resin include PEEK, and the like. Examples for such metal include stainless steel, and the like.

The filters 4 are attached to filter the sample and prevent the filler from leaking out, and are provided between the main body part 2 and the end fittings 3. The filters 4 are made of a material not deforming when the end fittings 3 are attached to the main body part 2, preferably made of, for example, a synthetic resin or a metal having characteristics of excellent heat resistance and pressure resistance in addition to not causing adsorption or denaturation of the sample. Examples for such synthetic resin include, for example, PEEK, PTFE, polyethylene, and the like; examples for such metal include, for example, stainless steel, titanium, bronze, bronze titanium, and the like; and examples of materials other than the synthetic resin or metal include glass, and the like, but other materials can be also optionally selected if these have characteristics of excellent heat resistance and pressure resistance in addition to not causing adsorption or denaturation of the sample.

The filters 4 of the present invention have structures with outer diameters smaller than an inner diameter of main body part 2; and the outer diameters are preferably, but not limited to, between 1.0 mm to 20.0 mm. The outer diameters of 4.5 cm can be suitably selected and used, but other outer diameters can be also optionally selected.

The thicknesses of filters 4 are preferably, but not limited to, between 0.2 mm and 5.0 mm. The thicknesses of 1.4 mm can be suitably selected and used, but other thicknesses can be also optionally selected.

The sleeves 5 are equipped around the filters 4, and preferably have inner diameters substantially equal to the outer diameters of filters 4. The sleeves 5 are made of a synthetic resin or the like that deforms when the end fittings 3 are attached to the main body part 2 via the structure bodies 6, and such synthetic resin can be selected from, for example, PEEK, PCTFE, PTFE, and the like, but other type of synthetic resin can be also optionally selected.

The thicknesses of sleeves 5 are preferably, but not limited to, thicker than or equal to the thicknesses of filters 4. The thicknesses of 1.5 mm can be suitably selected and used, but other thicknesses can be also optionally selected.

Furthermore, the filter 4 and the sleeve 5 configure an integrated structure body 6 by operations such as press-fitting. As a result, the structure bodies 6 in the column 1 of the present invention function in such a way that the sleeves 5 are compressed and the filters 4 are not compressed when the main body part 2 filled with a filler is sealed with the end fittings 3. The compression ratio of the sleeves 5, in other words, the value, which is, obtained by dividing the thicknesses of sleeves 5 after compression by the thicknesses of sleeves 5 before compression and then subtracting the divided value from 1 and expressed as a percentage, is preferably greater than 0% and up to 50%, but since the column 1 of the present invention requires a mechanism with the sleeves 5 compressed to improve the analytical performance, it should be noted that aspects with a compression rate exceeding 50% also exist.

The outer diameters of structure bodies 6 are preferably, but not limited to, larger than or equal to the inner diameters of end fittings 3.

The structure bodies 6 are placed or fixed inside of the end fittings 3 to be used. The structure bodies are preferably, but not limited to, fixed by press-fitting.

FIG. 2a is a sectional view of a conventional filter 4′, a conventional sleeve 5′, and a part of main body part 2, in a column 1′ being packed with a filler followed by attachment of an end fitting 3 which comprises structure body of the conventional filter 4′ and the conventional sleeve 5′. FIG. 2b is a sectional view of a filter 4, a sleeve 5, and a part of main body part 2, in a column 1 of the present invention having an end fitting 3 attached which comprises a structure body 6 of the filter 4 and the sleeve 5.

The structure bodies 6 in the column 1 of the present invention function in such a way that the sleeves 5 are compressed and the filters 4 are not compressed when the main body part 2 filled with a filler is sealed with the end fittings 3. With this structure, unlike a conventional column 1′ with filters 4′ not being pushed into the inside of the main body part 2, the column 1 according to the present invention has the filters 4 pushed into the inside of the main body part 2, thereby improving analytical performance (increasing theoretical plate number) and resolving the top-off by the filler. At this time, it is possible to decrease, to the greatest extent, the area where the sample or the filler comes into contact with the sleeves 5. Furthermore, the presence of sleeves 5 increases the sealing force from the end fittings, thereby being able to prevent the sample from leaking.

Embodiments of a manufacturing method of a column for high performance liquid chromatography (HPLC) according to the present invention will be explained below in detail.

A manufacturing method of a column 1 according to the present invention comprises the steps of: (a) obtaining structure bodies 6 in which filters 4 and sleeves 5 are integrated by press-fitting the filters 4 into the sleeves 5; and (b) placing or fixing the structure bodies 6 to end fittings 3 of the column 1.

Here, the step of (a) obtaining structure bodies 6 in which filters 4 and sleeves 5 are integrated by press-fitting the filters 4 into the sleeves 5 comprises the following procedures: (a1) placing the sleeves 5 on a press-fit tool; (a2) placing the filters 4 on the sleeves 5 placed on the press-fit tool; and (a3) press-fitting the filters 4 into the inside of the sleeves 5 using the press-fit tool. By these procedures, the structure bodies 6 in which the filters 4 and the sleeves 5 are integrated (assembled together) can be obtained. Since the filters 4 have structures with outer diameters about the same as the inner diameters of sleeves 5, this press-fitting operation makes the structure bodies 6 such that they cannot be easily separated into the filters 4 and the sleeves 5.

Furthermore, the step of (b) placing or fixing the structure bodies 6 to end fittings 3 of the column 1, comprises the following procedures: (b1) inserting (placing) the structure bodies 6 into the inside of the end fittings 3; and (b2) in case of fixing the structure bodies 6 to the inside of the end fittings 3, pressing by hand with a press-fit tool to press-fit the structure bodies 6 into the inside of the end fittings 3. These procedures integrates the end fittings 3 and the structure bodies 6. Examples for methods of fixing, other than press-fitting, include a welding method, and the like.

The column 1 according to the present invention is completed by fitting (e.g. screwing) one of the two sides of main body part 2 on which the end fittings 3 with the structure bodies 6 are placed or fixed; using the fitted side as the lower end and pouring the filler from another side (upper end) of the main body part 2 to fill the interior of the main body part 2 with the filler; and after the removal of the excess filler leaked out from the main body part 2, fitting (e.g. screwing) the upper end of main body part 2 with the end fittings 3 on which the structure bodies 6 are placed or fixed.

### EXAMPLES

### Example 1: Manufactured Column

In Example 1, the followings were adopted: a main body part 2 with a length of 150 mm; filters 4 with outer diameters of 99% to 93% of the inner diameter of main body part 2 and with thicknesses of 17% to 43% of the inner diameter of main body part 2; sleeves 5 with thicknesses of 100% to 125% of the thicknesses of filters 4; structure bodies 6 with outer diameters same as the inner diameters of end fittings 3; and the main body part 2 with an inner diameter of 4.6 mm are selected. Fixing by press-fitting was selected as the method of placing or fixing the structure bodies 6 to the end fittings 3. The silica gel having a surface treated with an octadecylsilyl group was selected as a filler.

### Example 2: Performance Comparison of Manufactured Column

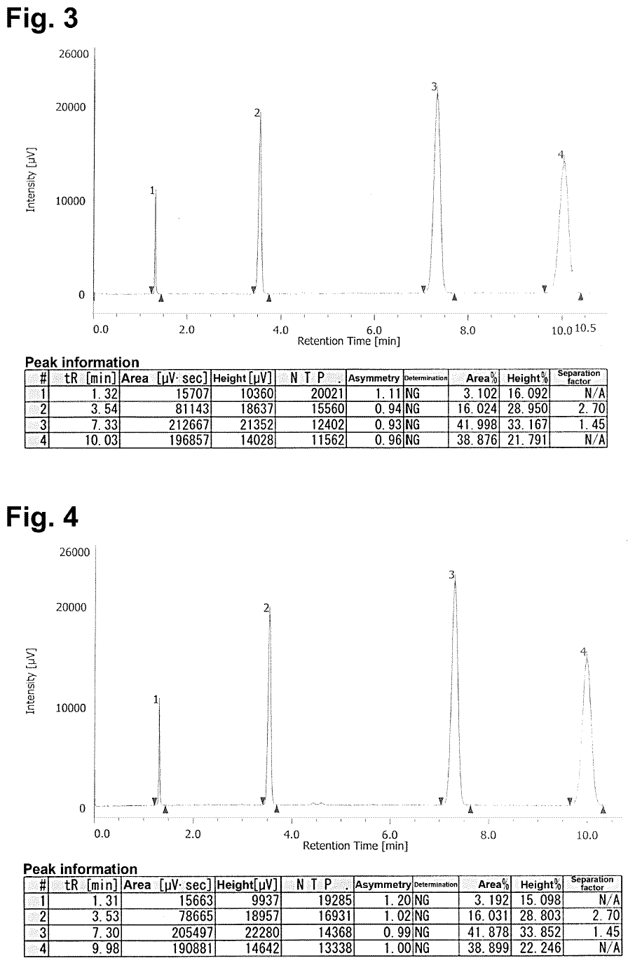

FIG. 3 is a figure showing the results of separating and analyzing a sample, in which uracil, ethyl benzoate, acenaphthene, and butylbenzene were mixed, by using a column 1 according to the present invention manufactured in Example 1. FIG. 4 is a figure showing the results of separating and analyzing a sample, in which uracil, ethyl benzoate, acenaphthene, and butylbenzene were mixed, by using a conventional column 1′.

Here, in an example of the present invention, the followings were used: filters 4 with outer diameters of 99% to 93% of the inner diameter of main body part 2; sleeves 5 with inner diameters same as the outer diameters of filters 4; structure bodies 6 with outer diameters same as the inner diameters of end fittings 3; and a main body part 2 with an inner diameter of 4.6 mm are used (the conventional filters 4′ have outer diameters of 101% to 110% of the inner diameter of main body part 2). A sample in which uracil, ethyl benzoate, acenaphthene, and butylbenzene were mixed, was separated and analyzed using the column 1 of the present invention. Since uracil, having the shortest retention time, is most affected by extra-column volume, and ethyl benzoate, acenaphthene, and butylbenzene are less affected, the theoretical plate numbers for uracil were compared. When comparing the results in FIG. 3 and FIG. 4, the result of using the conventional filters 4′ shows a theoretical plate number (half width method) for uracil of 19285, while the result of using the filters 4 of the present invention shows an increase in the theoretical plate number for uracil to 20021. Also, noise would appear in the data if the filler or sample had been leaking, but no noise was detected.

Also, by comparing the ratio of the theoretical plate number for uracil, which has the thinnest peak, in other words, the largest theoretical plate number, to the theoretical plate number for butylbenzene, which has the thickest peak, in other words, the smallest theoretical plate number, the difference of variation in analytical performance, which occurs in packing the filler into a column, can be negligible. As a result, in the case of using the conventional filter 4′ (conventional product), the value, which is obtained by dividing the theoretical plate number for uracil by the theoretical plate number for butylbenzene and then expressed as a percentage, was 145%, whereas the value in the case of the present invention was 173% (Table 1). The results showed that the present invention is a superior invention compared to the conventional product in terms of theoretical plate number.

TABLE 1

| | | Present invention | | Conventional product | |
|---|---|---|---|---|---|
| | | Theoretical | Peak | Theoretical | Peak |
| No. | Samples | plate number | ratio | plate number | ratio |
| 1 | uracil | 20021 | 100% | 19285 | 100% |
| 2 | ethyl benzoate | 15560 | 129% | 16931 | 1149% |
| 3 | acenaphthene | 12402 | 16196 | 14368 | 13496 |
| 4 | butylbenzene | 11562 | 1739% | 13338 | 145% |

### INDUSTRIAL APPLICABILITY

The present invention provides a column for high performance liquid chromatography (HPLC) with superior analytical performance compared to conventional products, while having few components and a simple structure and mechanism.

### EXPLANATIONS OF REFERENCES

1 column
2 main body part
3 end fitting
4 filter
5 sleeve
6 structure body

What is claimed is:

1. A column for high performance liquid chromatography (HPLC), the column comprising:
a main body part comprising a filler inside thereof;
end fittings attached to both ends of the main body part;
filters provided between the main body part and the end fittings; and
sleeves equipped around the filters,
wherein the filters and the sleeves configure integrated structure bodies,
wherein the structure bodies are placed or fixed inside the end fittings,
wherein the filters have outer diameters smaller than an inner diameter of the main body part,
wherein the structure bodies have outer diameters larger than the inner diameter of the main body part,
wherein the filters are made of a material that does not deform when the end fittings are attached to the main body part,
wherein the sleeves are made of a material that is deformable when the end fittings are attached to the main body part,
wherein the column is characterized in that when the end fittings are attached to the main body part, the sleeves are compressed, the filters are not compressed, and the filters are present inside the main body part so as to resolve a top-off by the filler.

2. The column of claim 1, wherein at least one of the main body part, the end fittings, and the filters is made of metal.

3. The column of claim 1, wherein at least one of the main body part, the end fittings, and the filters is made of synthetic resin.

4. A manufacturing method of a column for high performance liquid chromatography (HPLC), the manufacturing method comprising:
(a) obtaining structure bodies in which filters and sleeves are integrated by press-fitting the filters into the sleeves; and
(b) placing or fixing the structure bodies to end fittings of the column, wherein the column comprises a main body part comprising a filler inside thereof, the end fittings attached to both ends of the main body part, and the structure bodies between the main body part and the end fittings,
wherein the filters are made of a material that does not deform upon attachment of the end fittings to the main body part,
wherein the sleeves are made of a material that is deformable upon attachment of the end fittings to the main body part,
wherein the filters have outer diameters smaller than an inner diameter of the main body part,
wherein the structure bodies have outer diameters larger than the inner diameter of the main body part,
wherein the column is characterized in that upon attachment of the end fittings to the main body part, the sleeves are compressed so that the filters are inserted into the main body part.

5. The manufacturing method of claim 4, wherein at least one of the main body part, the end fittings, and the filters is made of metal.

6. The manufacturing method of claim 4, wherein at least one of the main body part, the end fittings, and the filters is made of synthetic resin.
